(19) United States
(12) Patent Application Publication
(10) Pub. No.: US 2015/0140508 A1
(43) Pub. Date: May 21, 2015

(54) Universal Retrofit Dental Abutment

(71) Applicant: Adaptall Manufacturing Inc., Mississauga (CA)

(72) Inventor: Leo NIKE, Mississauga (CA)

(73) Assignee: Adaptall Manufacturing Inc., Mississauga (CA)

(21) Appl. No.: 14/082,384

(22) Filed: Nov. 18, 2013

(51) Int. Cl. A61C 8/00

(52) U.S. Cl. CPC A61C 8/0065; A61C 8/0068
USPC 433/172

(57) ABSTRACT

A new dental implant with allows for repair of an existing root form implant after a traumatic event, which reduces or eliminates the need for further surgery. The implant uses an abutment which comprises a threaded spindle having an integrated taper, a plurality of segments around the axis of the spindle and a tapered nut threaded on the distal end of the spindle.

### FIELD OF THE INVENTION

This invention relates to dental implants and, in particular, a new dental implant which allows for repair of an existing root form implant after a traumatic event which reduces or eliminates the need for further surgery.

### BACKGROUND OF THE INVENTION

Dental implant systems are well known in the art for replacing one or more dead or missing teeth. For example, common dental implant systems include a base which is integrated into one of the upper and lower jaw, and an abutment which attaches to the base. The base is often called a root form, as it looks and behaves similar to the root or roots of a tooth or teeth. Once the abutment is attached to the root form, a dental prosthesis is bonded to the abutment using known techniques. The dental prosthesis may take the form of a replacement tooth, a bridge and the like.

Installing a dental implant into a patient's mouth is often a multi-step process. For example, typical approaches to implantation may include preparing a site for implantation, surgically inserting a root form into the jaw, allowing a sufficient amount of time for the root form to osseointegrate (i.e. fuse with the surrounding bone), connecting an abutment to the root form, and finally attaching a replacement prosthesis to the abutment. A multi-step process involving a multi-part dental implant system is the preferred approach for many dentists and dental surgeons, as it allows for the proper integration of the root form within the surrounding bone (usually taking between 2 to 6 months) without the root form being affected by a patient's chewing during the osseointregration step. When suitably integrated into the jaw, the root form may provide a solid anchor in which to attach the abutment and subsequent dental prosthesis may be connected.

Typical dental implant technology often employs the use of threads, both in the male and female configurations, to connect the abutment to the root form implanted within the jaw. For example, the dental implant may utilize corresponding threads on both the root form and the abutment to allow the abutment to be screwed into the root form. Once connected, the abutment may have an attachment connector or end for bonding a dental prosthesis to the abutment. The dental prosthesis may be glued, cemented or otherwise connected to the abutment.

While typical dental implants allow for the connection of a dental prosthesis to a root form, the inventors have appreciated that the diameter and pitch of different threaded abutments vary from one manufacturer to another. However, thread identification tools which could distinguish between manufacturers does not exist making the removal of broken threads impossible.

Furthermore, where a patient with an installed dental implant is involved in a trauma, such as a motor vehicle accident or a sports-related injury, a portion of the abutment may break off or shear. The threads of the abutment and/or root form may also become damaged by other means. If this occurs, a dentist or dental surgeon may have difficulty in removing the abutment from the root form and finding a replacement abutment.

The inventors have also appreciated that, in some cases, damage to the threads of the root form and/or the abutment may make removal or replacement of the damaged abutment impossible. In other cases, the dentist and/or dental surgeon may be unable to identify or distinguish the threads of the root form in order to locate a replacement abutment even with known thread identification tools. In this situation, the dentist or dental surgeon may be forced to remove the osseointegrated root form and begin the multi-step implantation process over again by installing a new root form. If a new root form is required, a patient will require adequate time (often months) to recover from the removal of the previous root form before the new root form can be surgically installed. Even more time will then be required for the new root form to become osseointegrated and for a new abutment and dental prosthetic to be put in place. Accordingly, replacing an installed dental implant with a new root form is both time-consuming and uncomfortable for the patient.

The root form is generally embedded in the jaw with drilling techniques applied by the implantologist or the dental surgeon. After an adequate period of time, the root form becomes sufficiently integrated with the going through the process of osseointegration to allow for connection to the abutment. The abutment is then connected to the root form through the use of threads in one form or another to achieve a stable connection before the mounting of the dental prosthesis.

### SUMMARY OF THE INVENTION

Accordingly, it is an object of this invention to provide an improved dental implant system.

In one aspect, the present invention provides an improved implant that will not require the removal of an osseointegrated implant in the event that there is a catastrophic failure due to an unforeseen traumatic event.

In another of its aspects, the invention provides an improved implant that will not require the removal of an osseointegrated implant in the event that there is a catastrophic failure due to an unforeseen traumatic event notwithstanding that the diameter or pitch of the threads of the abutment are unknown and cannot be determined.

In yet another of its aspects, the invention provides a new and improved abutment which may be used in a dental implant system which allows for the replacement of a dental prosthesis without removal of the osseointegrated implant.

In a further of its aspects, the invention provides a new and improved abutment which has eliminated the need to identify the diameter and pitch of the threads in the already embedded root form when a dental prosthesis needs to be replaced.

Other features of the invention will be apparent to those skilled in the art from the following detailed description of the embodiments thereof.

The invention comprises a dental abutment consisting of a threaded spindle having a longitudinal axis, a plurality of segments circumferentially affixed to the axis of the spindle and a tapered nut threaded on the distal end of the spindle.

### BRIEF DESCRIPTION OF THE DRAWINGS

Reference may now be had to the following detailed description taken together with the accompanying drawings in which:

FIG. 1 shows an exploded view of the dental abutment of the present invention.

FIG. 2 shows a perspective view of the segments;

FIG. 3 shows a perspective view of the sleeve;

FIG. 4 shows a perspective view of the threaded spindle;

FIG. 5 shows the assembled abutment;

FIG. 6 shows the tapered nut;

FIG. 7 shows the assemble segments of FIG. 2.

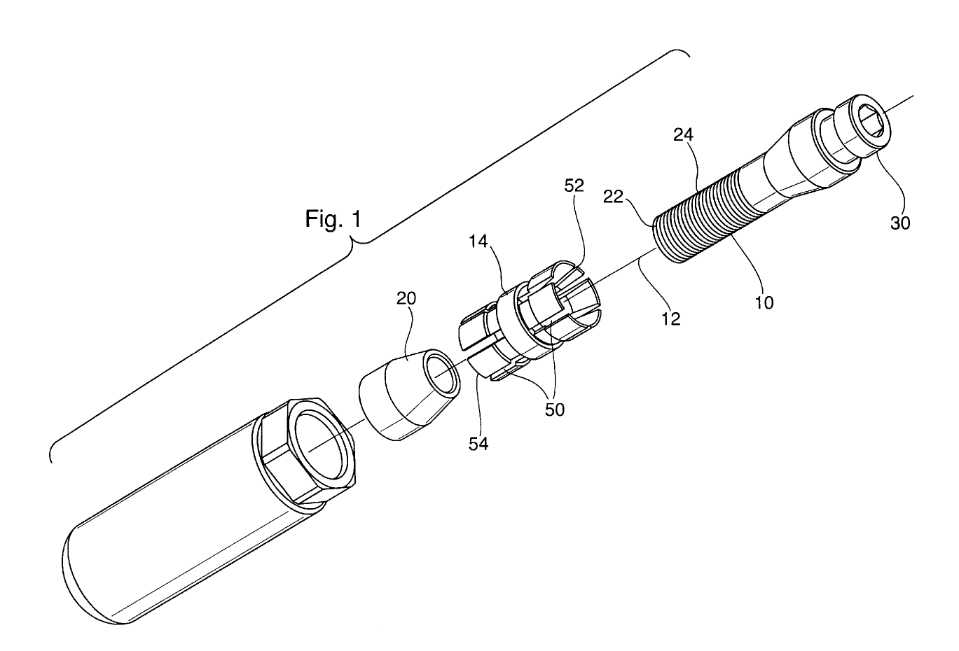

### DETAILED DESCRIPTION OF THE PREFERRED EMBODIMENTS

As illustrated in the drawings, the invention comprises a threaded spindle 10 having an integrated taper 11 and a longitudinal axis 12, a sleeve 14 circumferentially affixed to the threaded portion 24 of the spindle 10 and a tapered nut 20 threaded on the distal end 22 of the spindle 10.

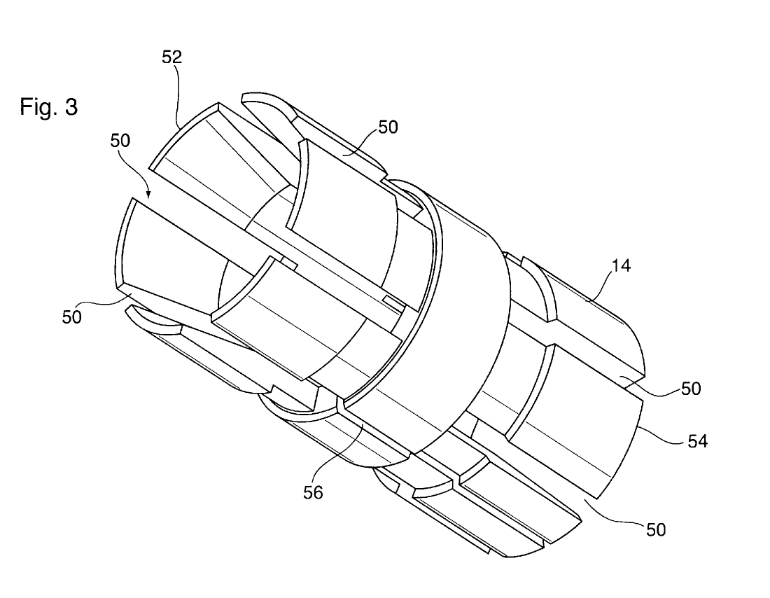

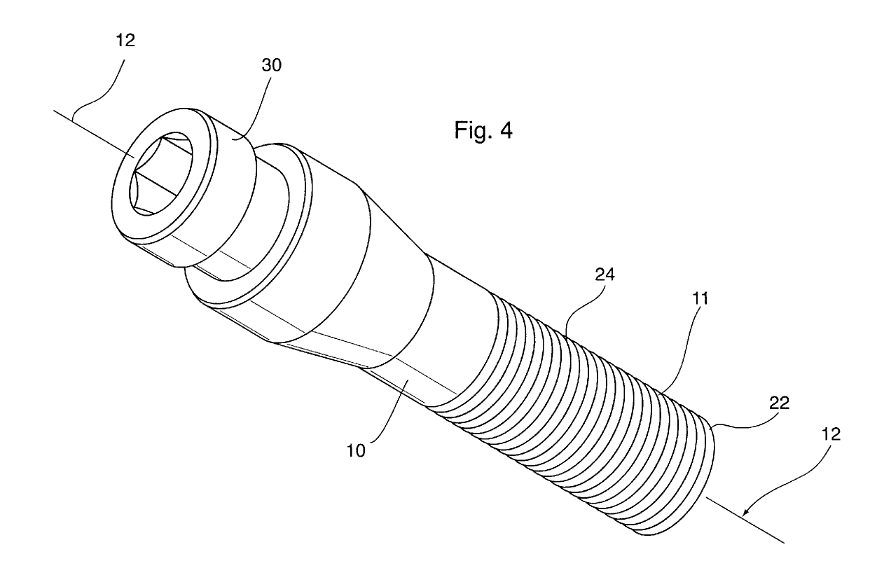

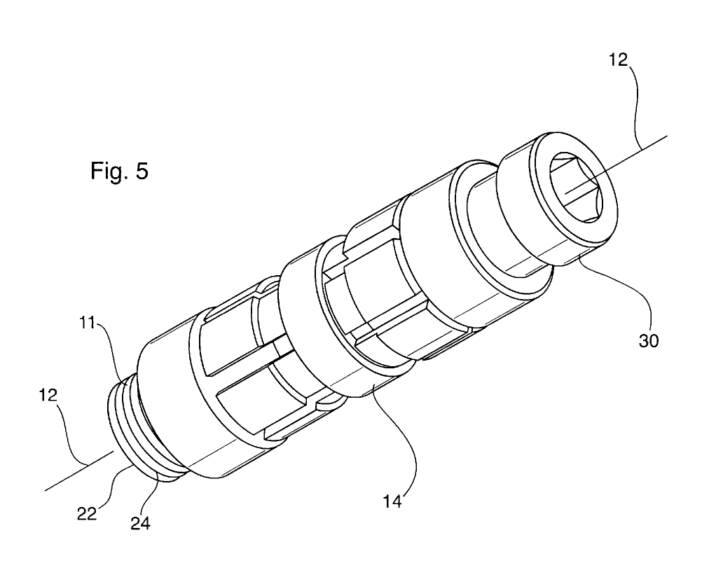

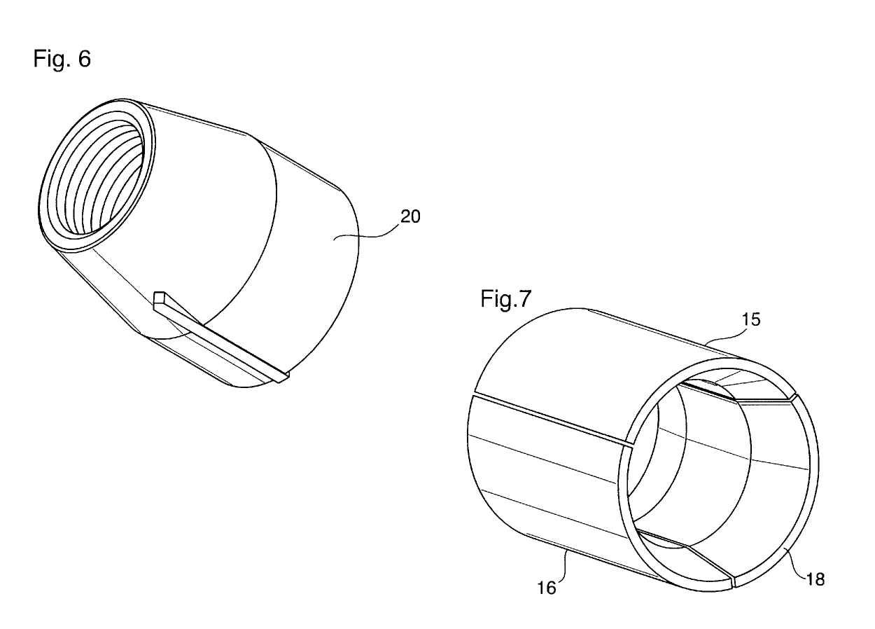

The sleeve 14 as shown in FIG. 3 has a single piece radial design which uses elongated slots 50 which are positioned alternatively from end 52 and end 54 to no more than one-half the length of the sleeve 14. One continuous slot 56 runs the entire length of the sleeve 14.

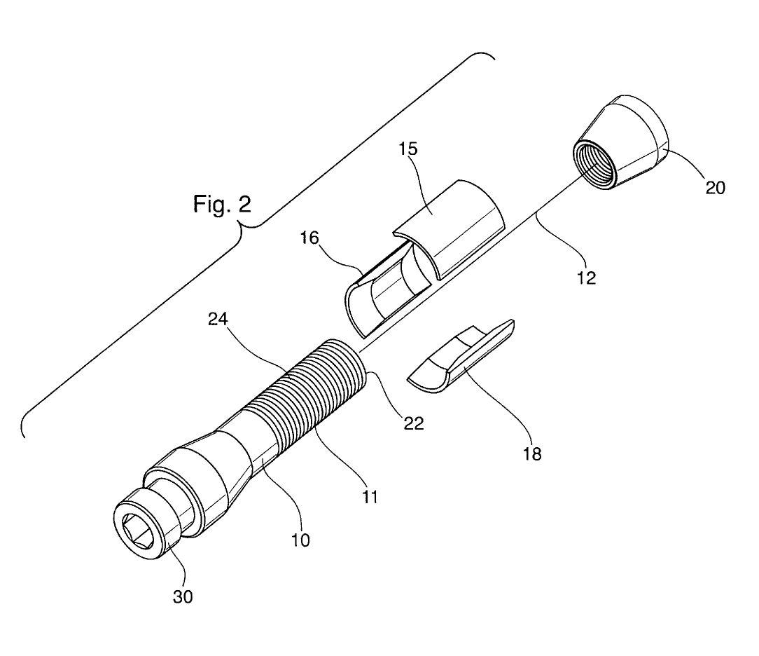

A second embodiment of the sleeve is shown in FIG. 2 which shows a plurality of segments 15, 16 and 18 circumferentially affixed to the threaded portion 24 of the spindle 10 and a tapered nut 20 threaded on the distal end 22 of the spindle.

While the figures show three segments 15, 16 and 18, the invention is not so restricted as any number of segments may be used which encompass the threaded portion 24 of the spindle 10.

The sleeve 14 or the segments 15, 16 and 18 may be secured to the threaded portion 24 of the spindle 10 by using a dental grade epoxy. Alternately, the segments may be held by an expansion spring which encompasses the segments 15, 16 and 18 in a groove (not shown).

In order to insert the novel abutment, the female threads of the osseointegrated root form implant are first progressively drilled as in the standard dental procedure done today to remove an implant. However, the implant is drilled only enough to remove the existing threads regardless of the pitch and standard of the manufacturer. The implant is drilled to a predetermined diameter internal diameter that would allow and facilitate the insertion of the new abutment.

Alternatively, it is also possible to insert the new abutment without drilling out the female threads of the osseointegrated root form implant.

The device is then assembled by securing the sleeve 14 or segments 15, 16 and 18 to the threaded portion 24 and the tapered nut 20 is inserted on the distal end of the abutment. The abutment is then inserted into the root form implant.

Spindle 10 has at its opposite end, a driver portion 30 which draws the tapers into the sleeve or the segments creating a radial movement tangential to the longitudinal axis 12 of the spindle 10 which generates enough force to holds the abutment in place.

The abutment assembly may be inserted by means of surgical tweezers and is aligned in the root form by means of the spindle 10 interacting with the root form.

After installation, the implantologist or dentist can move place the prosthesis on the end of the abutment as in the prior art.

The driver portion 30 of the spindle 10 can be operated with any suitable means such as a socket head set screw arrangement which uses a hexagonal key to turn the spindle 10. Other examples of suitable devices would include a wrench and a small head or a small socket to achieve the desired locking. A clear advantage is that the torque requirements would be minimal.

When the sleeve is used in the invention, when the driver portion is drawn into the tapers, the key on the driver portion aligns with the slot to provide linear stability while the spindle actuation affects the locking feature.

The continuous slot is provided to give linear stability during the tightening phase and it allows also for easy radial expansion with minimum force applied to the spindle to achieve adequate lock up.

As the spindle is rotated, the key resists rotation by virtue of its engagement within the continuous slot to effectively operate as one unit on a radial plane while remaining in function on a linear plane.

The abutment may be of a suitable biocompatible material such as, for example, medical-grade titanium and the like.

Commercially available medical grade titanium is available in for separate grades which encompasses different levels of ductility and rigidity. These also offer very stable oxide surfaces which when subject to damage, demonstrate self-healing properties in the presence of air and water. Thus this stable oxide lends itself well to osseointegration.

A second suitable material is the class of cobalt-chromium-molybdenum based alloys. These alloys have good conventional machining properties useful for extreme geometries due to the presence of the cobalt and the chromium adds corrosion resistance and provide a good oxide surface. Strength is added by the presence of he molybdenum. Dental implants made from these alloys have demonstrated excellent biocompatibility. It should be noted that cast cobalt should be avoided because implants made of this material are the least ductile materials used in surgical dental implants and manufacturing techniques that incorporate a bending procedure after casting should be avoided.

A third suitable material is the group of iron-chromium-nickel alloys which include stainless steels and a group known as austenitic stainless. These alloys can be passiviated after machining to provide an oxide surface for osseointegration. If any allergenic potential is noted, these alloys should be avoided. These alloys should also not be used in concert with titanium, cobalt or zirconium and carbon based biomaterials because of their tendency for galvanic corrosion when combined.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein. The scope of the claims should not be limited by the preferred embodiments set forth in the examples, but should be given the broadest interpretation consistent with the description as a whole.

It will be understood that, although various features of the invention have been described with respect to one or another of the embodiments of the invention, the various features and embodiments of the invention may be combined or used in conjunction with other features and embodiments of the invention as described and illustrated herein.

The embodiments of the invention in which an exclusive property or privilege is claimed is defined as follows:

1. A dental abutment for use in implant procedures, said abutment comprising a threaded spindle having an integrated taper and a longitudinal axis, a plurality of segments circumferentially affixed to the axis of the spindle and a tapered nut threaded on the distal end of the spindle.

2. A dental abutment as claimed in claim 1 wherein said three segments are circumferentially affixed to the axis of the spindle.

3. A dental abutment as claimed in claim 2 wherein said segments are affixed by the use of a dental grade epoxy.

4. A dental abutment as claimed in claim 2 wherein said segments are affixed by the use of an expansion spring.

5. A dental abutment for use in implant procedures, said abutment comprising a threaded spindle having an integrated taper and a longitudinal axis, a sleeve circumferentially affixed to the axis of the spindle and a tapered nut threaded on the distal end of the spindle.

6. A dental abutment as claimed in claims 1 and 5 made of a suitable biocompatible material.

7. A dental abutment as claimed in claim 6 where said material is medical-grade titanium.

8. A dental abutment as claimed in claim 6 where said material is a cobalt-chromium-molybdenum alloy.

9. A dental abutment as claimed in claim 6 where said material is an iron-chromium-nickel alloy.

10. A dental abutment as claimed in claims 1 and 5 wherein said threaded spindle has a driver portion for driving the tapered portion of the spindle into the segments.
